(19) United States
(12) Patent Application Publication
(10) Pub. No.: US 2017/0208600 A1
(43) Pub. Date: Jul. 20, 2017

(54) METHODS FOR ENHANCING PERFORMANCE OF A COMMUNICATIONS APPARATUS SUFFERING FROM DOPPLER EFFECT AND COMMUNICATIONS APPARATUS UTILIZING THE SAME

(71) Applicant: MEDIATEK INC., Hsin-Chu (TW)

(72) Inventors: Hsinyueh HSU, Hsinchu City (TW); Chung-Hsuan HU, Miaoli City (TW); Chun-Ming KUO, Hsinchu City (TW)

(21) Appl. No.: 15/405,365

(22) Filed: Jan. 13, 2017

Related U.S. Application Data
(60) Provisional application No. 62/280,150, filed on Jan. 19, 2016.

(51) Int. Cl. H04W 72/08; H04W 72/04; G01S 11/10; H04W 48/18

(52) U.S. Cl. CPC H04W 72/085; H04W 48/18; H04W 72/0453; G01S 11/10

(57) ABSTRACT

A communications apparatus includes a radio transceiver and a processor. The radio transceiver transmits or receives wireless radio frequency signals to communicate with a first network device. The processor estimates a first Doppler frequency shift value corresponding to a first carrier frequency utilized for communicating with the first network device, and adjusts the first carrier frequency to an adjusted first carrier frequency according to the first Doppler frequency shift value and communicates with the first network device according to the adjusted first carrier frequency via the radio transceiver or adjusts a first value of a measured signal quality of the first network device to an adjusted first value according to the first Doppler frequency shift value and transmits a first measurement report with the adjusted first value via the radio transceiver to the first network device.

### CROSS REFERENCE TO RELATED APPLICATIONS

This application claims the benefit of U.S. Provisional Application No. 62/280,150 filed 2016 Jan. 19 entitled “MS enhancement for high speed scenario,” the entire contents of which are hereby incorporated by reference.

### BACKGROUND OF THE INVENTION

Field of the Invention

The invention relates to methods for enhancing performance of a communications apparatus suffering from the Doppler Effect.

Description of the Related Art

It is well known that the frequency spectrum of a radio transmission between a moving vehicle (mobile body) and a base station fixed to the ground undergoes some variations as a result of the Doppler Effect. Doppler Effect for many 3G cellular systems (e.g., CDMA2000, W-CDMA, TD-SCDMA, etc.) is a less concerning issue. However next-generation LTE systems will use higher-order modulation schemes, yielding 86 to 100 Mbps, which will be more sensitive to Doppler frequency shifts, possibly resulting in the loss of communication link or poor bandwidth in high speed/high Doppler frequency shift environments.

To enhance the quality of a radio transmission in a high-speed scenario, methods for enhancing the performance of a communications apparatus suffering from the Doppler Effect are proposed.

### BRIEF SUMMARY OF THE INVENTION

Communications apparatus and methods for enhancing performance of a communications apparatus suffering from Doppler effect are provided. An exemplary embodiment of a communications apparatus includes a radio transceiver and a processor. The radio transceiver transmits or receives wireless radio frequency signals to communicate with a first network device. The processor estimates a first Doppler frequency shift value corresponding to a first carrier frequency utilized for communicating with the first network device, and adjusts the first carrier frequency to an adjusted first carrier frequency according to the first Doppler frequency shift value and communicates with the first network device according to the adjusted first carrier frequency via the radio transceiver or adjusts a first value of a measured signal quality of the first network device to an adjusted first value according to the first Doppler frequency shift value and transmits a first measurement report with the adjusted first value via the radio transceiver to the first network device.

An exemplary embodiment of a method for enhancing performance of a communications apparatus suffering from Doppler effect comprises: estimating a Doppler frequency shift value corresponding to a carrier frequency utilized by the communications apparatus to communicate with a network device; adjusting the carrier frequency to an adjusted carrier frequency according to the Doppler frequency shift value; and using the adjusted carrier frequency to communicate with the network device.

Another exemplary embodiment of a method for enhancing performance of a communications apparatus suffering from Doppler effect comprises: estimating a first Doppler frequency shift value corresponding to a first carrier frequency utilized by the communications apparatus to communicate with a first network device; adjusting a first value of a measured signal quality of the first network device to an adjusted first value according to the first Doppler frequency shift value; and transmitting a first measurement report with the adjusted first value to the first network device.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an exemplary block diagram of a communications apparatus according to an embodiment of the invention;

FIG. 2 shows an exemplary block diagram of a modem according to an embodiment of the invention;

FIG. 3 is a flow chart of a method for enhancing performance of a communications apparatus suffering from Doppler Effect according to a first embodiment of the invention;

FIG. 4 is a flow chart of a method for enhancing performance of a communications apparatus suffering from Doppler Effect according to a second embodiment of the invention; and

FIG. 5 shows an exemplary message flow for transmitting a measurement report according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

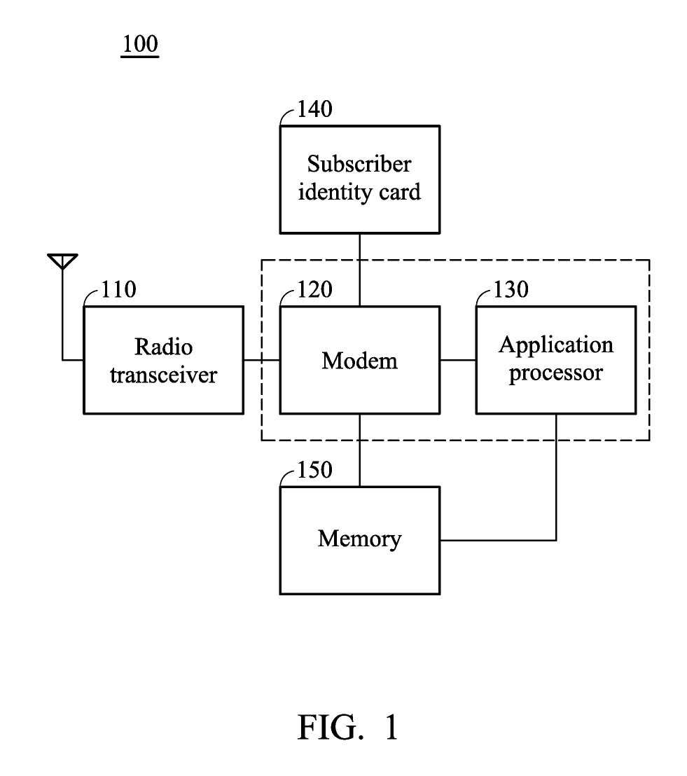

FIG. 1 shows an exemplary block diagram of a communications apparatus according to an embodiment of the invention. The communications apparatus 100 may be a portable electronic device, such as a Mobile Station (MS, which may be interchangeably referred to as User Equipment (UE)). The communications apparatus 100 may comprise at least an antenna module comprising at least one antenna, a radio transceiver 110, a modem 120, an application processor 130, a subscriber identity card 140, and a memory 150. The radio transceiver 110 may receive wireless radio frequency signals via the antenna module, transmit wireless radio frequency signals via the antenna module and perform RF signal processing. For example, the radio transceiver 110 may convert the received signals to intermediate frequency (IF) or baseband signals to be processed, or receive the IF or baseband signals from the modem 120 and convert the received signals to wireless radio frequency signals to be transmitted to a network device. According to an embodiment of the invention, the network device may be a cell, an evolved node B, a base station, a Mobility Management Entity (MME) etc., at the network side and communicating with the communications apparatus 100 via the wireless radio frequency signals.

The radio transceiver 110 may comprise a plurality of hardware devices to perform radio frequency conversion and RF signal processing. For example, the radio transceiver 110 may comprise a power amplifier for amplifying the RF signals, a filter for filtering unwanted portion in the RE signals and/or a mixer for performing radio frequency conversion. According to an embodiment of the invention, the radio frequency may be, for example, 900 MHz or 1800 MHz for a Global System for Mobile communication (GSM), or 1900 MHz for a Universal Mobile Telecommunications System (UMTS), or the frequency of any specific frequency band for a Long-Term Evolution (LTE) system, etc.

The modem 120 may be a cellular communications modem configured for handling cellular system communications protocol operations and processing the IF or baseband signals received from or to be transmitted to the radio transceiver 110. The application processor 130 is configured for running the operating system of the communications apparatus 100 and running application programs installed in the communications apparatus 100. In the embodiments of the invention, the modem 120 and the application processor 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a SIM, USIM, R-UIM or CSIM card, or the like and may typically contain user account information, an International Mobile Subscriber Identity (IMSI) and a set of SIM application toolkit (SAT) commands and may provide storage space for phone book contacts. The memory 150 may be coupled to the modem 120 and application processor 130 and may store system data or user data.

Note that, in order to clarify the concept of the invention, FIG. 1 presents a simplified block diagram in which only the elements relevant to the invention are shown. For example, in some embodiments of the invention, the communications apparatus may further comprise some peripheral devices not shown in FIG. 1. In another example, in some embodiments of the invention, the communications apparatus may further comprise a central controller coupled to the modem 120 and the application processor 130. Therefore, the invention should not be limited to what is shown in FIG. 1.

Note further that although FIG. 1 shows a single-card single-standby application, the invention should not be limited thereto. For example, in some embodiments of the invention, the communications apparatus may comprise multiple subscriber identity cards to support multiple radio access technologies (RATs) communications. In the multiple RATs communications applications, the modem, the radio transceiver and/or the antenna module may be shared by the subscriber identity cards and may have the capability of handling the operations of multiple cellular system communications protocols and processing the corresponding RF, IF or baseband signals in compliance with multiple cellular system communications protocols. Those who are skilled in this technology can still make various alterations and modifications based on the descriptions given above to derive the communications apparatuses comprising multiple radio transceivers and/or multiple antenna modules for supporting multiple RAT wireless communications without departing from the scope and spirit of this invention. Therefore, in some embodiments of the invention, the communications apparatus may be designed to support a multi-card multi-standby application by making some alterations and modifications.

Note further that the subscriber identity card 140 may be dedicated hardware cards as described above, or in some embodiments of the invention, there may be individual identifiers, numbers, addresses, or the like which are burned in the internal memory device of the corresponding modem and are capable of identifying the communications apparatus. Therefore, the invention should not be limited to what is shown in the figures.

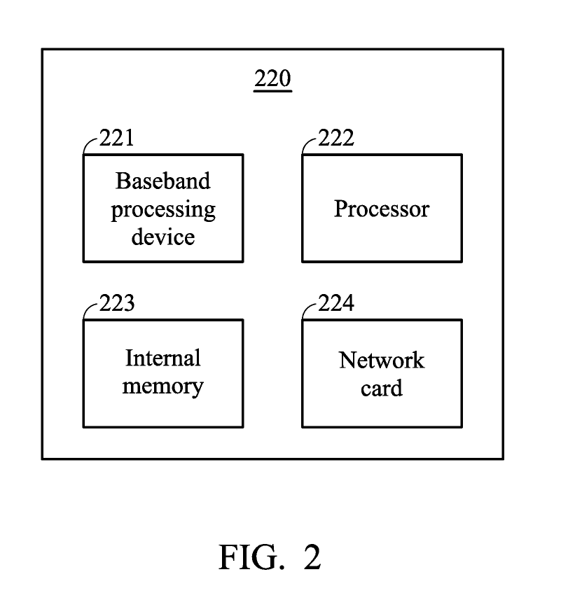

FIG. 2 shows an exemplary block diagram of a modem according to an embodiment of the invention. The modem 220 may be the modem 120 shown in FIG. 1 and may comprise at least a baseband processing device 221, a processor 222, an internal memory 223 and a network card 224. The baseband processing device 221 may receive the IF or baseband signals from the radio transceiver 110 and perform IF or baseband signal processing. For example, the baseband processing device 221 may convert the IF or baseband signals to a plurality of digital signals, and process the digital signals, and vice versa. The baseband processing device 221 may comprise a plurality of hardware devices to perform signal processing, such as an analog-to-digital converter for ADC conversion, a digital-to-analog converter for DAC conversion, an amplifier for gain adjustment, a modulator for signal modulation, a demodulator for signal demodulation, a encoder for signal encoding, a decoder for signal decoding, and so on.

The processor 222 may control the operations of the modem 220. According to an embodiment of the invention, the processor 222 may be arranged to execute the program codes of the corresponding software module of the modem 220. The processor 222 may maintain and execute the individual tasks, threads, and/or protocol stacks for different software modules. In a preferred embodiment, a protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

The processor 222 may also read data from the subscriber identity card coupled to the modem, such as the subscriber identity card 140, and write data to the subscriber identity card. The internal memory 223 may store system data and user data for the modem 220. The processor 222 may also access the internal memory 223.

The network card 224 provides Internet access services for the communications apparatus. Note that although the network card 224 shown in FIG. 2 is configured inside of the modem, the invention should not be limited thereto. In some embodiments of the invention, the communications apparatus may also comprise a network card configured outside of the modem, or the communications apparatus may also be coupled to an external network card for providing Internet access services. Therefore, the invention should not be limited to any specific implementation method.

Note further that, in order to clarify the concept of the invention, FIG. 2 presents simplified block diagrams in which only the elements relevant to the invention are shown. Therefore, the invention should not be limited to what is shown in FIG. 2.

Note further that in some embodiments of the invention, the modem may comprise more than one processor and/or more than one baseband processing device. For example, the modem may comprise multiple processors and/or multiple baseband processing devices for supporting multi-RAT operations. Therefore, the invention should not be limited to what is shown in FIG. 2.

As discussed above, the frequency spectrum of a radio transmission undergoes some variations coming from the Doppler Effect. Therefore, a communications apparatus may suffer from degradation in communications quality due to the Doppler Effect. The degradation may become serious when the communications apparatus is in a high moving speed scenario, such as in a high speed vehicle, e.g., Japan Tohoku Shinkansen (320 km/h), German ICE (330 km/h), AGV Italo (400 km/h), and Shanghai Maglev (430 km/h), moving faster than 300 km/h.

With a worldwide increase in deploying such high-speed environments, the demand for using wireless communications services in high-speed scenarios has increased as well. Therefore, methods for enhancing the performance of a communications apparatus suffering from the Doppler Effect are required.

According to an embodiment of the invention, the processor (e.g. the processor 222) of the communications apparatus may estimate a Doppler frequency shift value corresponding to a carrier frequency utilized for communicating with a network device. In the embodiments of the invention, the processor may derive the carrier frequency utilized for communicating with the network device according to a radio frequency carrier number corresponding to the network device, such as the Absolute Radio Frequency Carrier Number (ARFCN), UTRA Absolute Radio Frequency Channel Number (UARFCN), EUTRA Absolute Radio Frequency Channel Number (EARFCN), etc.

The processor may calculate a cross correlation between a pilot signal and a downlink signal received from the network device to estimate the Doppler frequency shift value. For example, the processor may estimate the Doppler frequency shift value by inspecting the cross correlation result to find the position with the peak value, and estimate the Doppler frequency shift value according to the difference between the frequency corresponding to the position having the peak value and the carrier frequency of the network device.

According to an embodiment of the invention, the processor may estimate the Doppler frequency shift value corresponding to one or more network devices. For example, in a cell selection procedure, the processor may estimate the Doppler frequency shift value corresponding to each candidate cell or each neighboring cell. In another example, when operating in an idle mode or a connected mode, the processor may estimate the Doppler frequency shift value corresponding to the serving cell that the communications apparatus is currently camped on and the Doppler frequency shift value corresponding to one or more neighboring cells.

According to an embodiment of the invention, the processor may determine whether the communications apparatus is in a high moving speed scenario according to the Doppler frequency shift values corresponding to different network devices. For example, when the difference between two estimated Doppler frequency shift values corresponding to two different network devices exceeds a threshold value, the processor may determine that the communications apparatus is in a high-speed scenario.

When determining that the communications apparatus is in a high-speed scenario, the processor may determine that the communications apparatus may suffer from the Doppler Effect and the processor may apply the proposed methods for enhancing performance of a communications apparatus suffering from the Doppler Effect. The proposed methods will be discussed in the following embodiments.

According to a first aspect of the invention, the uplink frequency may be controlled to compensate for the Doppler frequency shift.

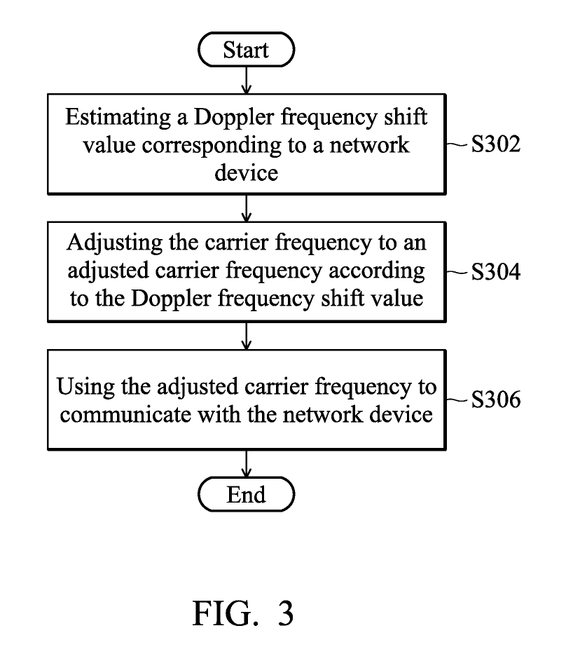

FIG. 3 is a flow chart of a method for enhancing performance of a communications apparatus suffering from the Doppler Effect according to a first embodiment of the invention. The processor may first estimate a Doppler frequency shift value corresponding to a carrier frequency utilized by the communications apparatus to communicate with a network device (that is, the Doppler frequency shift value corresponding to the network device) (Step S302). Next, the processor may adjust the carrier frequency to an adjusted carrier frequency according to the Doppler frequency shift value (Step S304). Next, the processor may use the adjusted carrier frequency to communicate with the network device (Step S306). To be more specific, the radio transceiver 110 may transmit wireless radio frequency signals oscillating at the adjusted carrier frequency to the network device.

According to an embodiment of the invention, the carrier frequency adjusted according to the Doppler frequency shift value is an uplink carrier frequency utilized by the communications apparatus to communicate with the network device.

According to an embodiment of the invention, when the Doppler frequency shift value is a positive value, the processor may decrease the carrier frequency by an offset to obtain the adjusted carrier frequency. The offset may be positively related to the absolute value of the estimated Doppler frequency shift value.

According to another embodiment of the invention, when the Doppler frequency shift value is a negative value, the processor may increase the carrier frequency by an offset to obtain the adjusted carrier frequency. The offset may be positively related to the absolute value of the estimated Doppler frequency shift value.

According to yet another embodiment of the invention, the processor may subtract the estimated Doppler frequency shift value from the carrier frequency to obtain the adjusted carrier frequency.

Note that conventionally, the communications apparatus is supposed to use the carrier frequency derived from the radio frequency carrier number as discussed above to communicate with the network device. The carrier frequency and the radio frequency carrier number are well-defined by the RAT. However, in the embodiments of the invention, to compensate for the Doppler frequency shift so as to mitigate degradation in communications quality due to the Doppler Effect, the communications apparatus uses an adjusted carrier frequency which is different from the original carrier frequency derived from the radio frequency carrier number to communicate with the network device. In this manner, because the carrier frequency is adjusted according to the estimated Doppler frequency shift value, the Doppler frequency shift generated due to the Doppler Effect can be compensated for and the communications apparatus can suffer from less communications quality degradation when being in a high-speed scenario.

Note further that the processor may also apply the method as illustrated above for communicating with more than one network device. For example, the processor may not only adjust the carrier frequency utilized for communicating with a serving cell, but also adjust the carrier frequency utilized for communicating with one or more neighboring cells.

According to a second aspect of the invention, a cell selection procedure and a measurement report procedure may be controlled to compensate for the Doppler frequency shift.

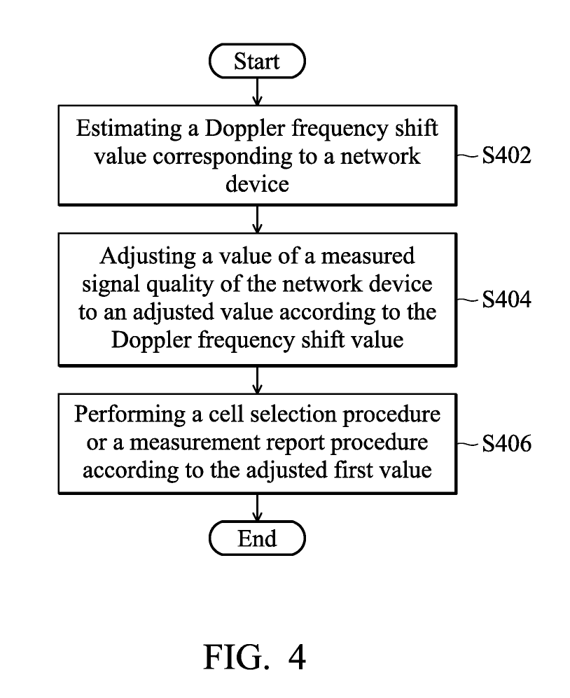

FIG. 4 is a flow chart of a method for enhancing the performance of a communications apparatus suffering from the Doppler Effect according to a second embodiment of the invention. The processor may first estimate a Doppler frequency shift value corresponding to a carrier frequency utilized by the communications apparatus to communicate with a network device (Step S402). Next, the processor may adjust the value of a measured signal quality of the network device to an adjusted value according to the Doppler frequency shift value (Step S404). Next, the processor may performing a cell selection procedure or a measurement report procedure according to the adjusted first value (Step S406).

The processor may perform periodic or aperiodic measurements to measure signal quality of one or more network devices and obtain a measured signal quality corresponding to each network device. The signal quality may be measured according to a power of downlink signals received from the network device, a receiving level of downlink signals received from the network device, a signal-to-noise ratio of downlink signals received from the network device, etc.

According to an embodiment of the invention, when the communications apparatus is positioned in a moving vehicle and moving in a network environment comprising one or more network devices, the communications apparatus may determine whether it is leaving or approaching the network devices according to the estimated Doppler frequency shift value. When the estimated Doppler frequency shift value is a positive value, the communications apparatus may determine that the communications apparatus is approaching the network device. Since the communications apparatus is approaching the network device, the measured signal quality corresponding to the network device may be adjusted to a value that is higher than the actual measured result. When the estimated Doppler frequency shift value is a negative value, the communications apparatus may determine that the communications apparatus is leaving the network device. Since the communications apparatus is leaving the network device, the measured signal quality corresponding to the network device may be adjusted to a value that is lower than the actual measured result.

Based on this concept, according to an embodiment of the invention, when the Doppler frequency shift value is a positive value, the processor may increase the value of the measured signal quality by an offset to obtain the adjusted value. The offset may be positively related to the absolute value of the estimated Doppler frequency shift.

According to an embodiment of the invention, when the Doppler frequency shift value is a negative value, the processor may decrease the value of the measured signal quality by an offset to obtain the adjusted value. The offset may be positively related to the absolute value of the estimated Doppler frequency shift.

Note that the processor may also apply the method as illustrated above for adjusting the measured signal quality of more than one network device. For example, the processor may not only adjust the measured signal quality of a serving cell, but also adjust the measured signal quality of one or more neighboring cells or candidate cells which are cell selection candidates.

Different from the conventional approaches, in which the communications apparatus directly reports the actual measured result in the measurement report, in the proposed methods, the communications apparatus reports an adjusted value in the measurement report. In addition, different from the conventional approaches, in which the communications apparatus directly use the actual measured result(s) of the candidate cell(s) to select a suitable cell in a cell selection procedure, in the proposed methods, the communications apparatus select a suitable cell based on the adjusted value(s) of the candidate cell(s). The reason to adjust the value of the measured signal quality is to increase the possibility for the communications apparatus to camp on or handover to a cell that the communications apparatus is approaching. Since the communications apparatus is approaching the cell, when the communications apparatus successfully camps on or handover to the cell, the signal quality may be getting stronger and the communications apparatus can suffer less communications quality degradation.

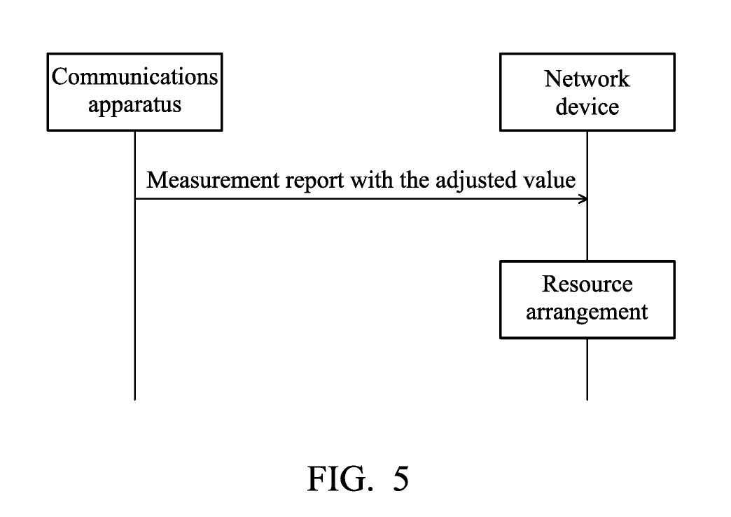

FIG. 5 shows an exemplary message flow for transmitting a measurement report according to an embodiment of the invention. The communications apparatus may transmit a measurement report with the adjusted value discussed above to the network device. Upon receiving the measurement report, the network device may perform resource arrangement according to the measurement report.

According to an embodiment of the invention, in a cell selection procedure, the processor may estimate the Doppler frequency shift value corresponding to each candidate cell or each neighboring cell. The processor may determine whether the communications apparatus is in a high moving speed scenario according to the Doppler frequency shift values corresponding to different cells.

When the processor determines that the communications apparatus is in a high moving speed scenario, the processor may adjust the measured signal quality of one or more candidate cells or neighboring cells, perform a cell selection procedure to determine which cell is a suitable network device (suitable cell) for the communications apparatus to camp on according to the adjust signal quality of the one or more candidate cells (e.g. select a suitable network device (suitable cell) with better or the best adjusted signal quality), and perform a camp on procedure to camp on the suitable network device.

The processor may also transmit a measurement report with the adjusted value(s) to one candidate cell or neighboring cell (the network device shown in FIG. 5). The processor may increase the measured signal quality of a cell that the communications apparatus is approaching and/or decrease the measured signal quality of a cell that the communications apparatus is leaving.

In this manner, the communications apparatus may preferentially camp on the cell that the communications apparatus is approaching, and communications quality can suffer from less degradation.

According to another embodiment of the invention, when the communications apparatus operates in a connected mode, the processor may estimate the Doppler frequency shift value corresponding to the serving cell and one or more neighboring cells. The processor may determine whether the communications apparatus is in a high moving speed scenario according to the Doppler frequency shift values corresponding to different cells.

When the processor determines that the communications apparatus is in a high moving speed scenario and the communications apparatus is leaving the serving cell and approaching a neighboring cell, the processor may increase the measured signal quality of the neighboring cell that the communications apparatus is approaching and/or decrease the measured signal quality of the serving cell, and transmit a measurement report with the adjusted value(s) to the serving cell (the network device as shown in FIG. 5).

Upon receiving the measurement report, the network device may determine whether a handover procedure is to be triggered according to the measurement report and transmit an indication to the communications apparatus.

Note that in a high moving speed scenario, the timing of triggering the handover procedure is critical. If the handover procedure is triggered too late, the communications link may be disconnected and call drop may occur since signal quality may suddenly drop as the communications apparatus is leaving the serving cell and has not yet been handed over to the target cell.

However, in the embodiments of the invention, since the measured signal quality carried in the measurement report has been adjusted according to the estimated Doppler frequency shift values, the handover procedure may be triggered earlier than in the conventional design. In this manner, the communications apparatus can be handed over to the target cell that the communications apparatus is approaching, and the communications apparatus can suffer less communications quality degradation.

As discussed above, in some embodiments of the invention, the processor may determine whether the communications apparatus is in a high moving speed scenario according to the Doppler frequency shift values corresponding to different cells. When the communications apparatus is in a high moving speed scenario, a function to compensate for the Doppler frequency shift by applying the methods as illustrated above may be enabled.

Note that in some other embodiments of the invention, the processor may also determine whether the communications apparatus is in a high moving speed scenario according to the information received from the network device or according to the information received from the user interface. For example, when communications apparatus enters a dedicated network deployed for a high speed vehicle, the network device may transmit information regarding the dedicated network to the communications apparatus, and thereby the processor may enable the function to compensate for the Doppler frequency shift. In another example, the user of the communications apparatus may also manually enable a function to compensate for the Doppler frequency shift when determining that the communications apparatus is in a high moving speed scenario.

When the function to compensate for the Doppler frequency shift is enabled, the methods for enhancing performance of a communications apparatus as illustrated above may be applied, so as to mitigate degradation of communications quality due to the Doppler Effect and enhance the quality of the communications link.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications apparatus, comprising:
a radio transceiver, transmitting or receiving wireless radio frequency signals to communicate with a first network device; and
a processor, estimating a first Doppler frequency shift value corresponding to a first carrier frequency utilized for communicating with the first network device, and adjusting the first carrier frequency to an adjusted first carrier frequency according to the first Doppler frequency shift value and communicating with the first network device according to the adjusted first carrier frequency via the radio transceiver or adjusting a first value of a measured signal quality of the first network device to an adjusted first value according to the first Doppler frequency shift value.

2. The communications apparatus as claimed in claim 1, wherein the processor further transmits a first measurement report with the adjusted first value via the radio transceiver to the first network device.

3. The communications apparatus as claimed in claim 1, wherein the first carrier frequency is an uplink carrier frequency, and when the first Doppler frequency shift value is a positive value, the processor adjusts the first carrier frequency by decreasing the first carrier frequency by an offset to obtain the adjusted first carrier frequency.

4. The communications apparatus as claimed in claim 1, wherein the first carrier frequency is an uplink carrier frequency, and when the first Doppler frequency shift value is a negative value, the processor adjusts the first carrier frequency by increasing the first carrier frequency by an offset to obtain the adjusted first carrier frequency.

5. The communications apparatus as claimed in claim 1, wherein the first carrier frequency is an uplink carrier frequency, and the processor adjusts the first carrier frequency by subtracting the first Doppler frequency shift value from the first carrier frequency to obtain the adjusted first carrier frequency.

6. The communications apparatus as claimed in claim 1, wherein when the first Doppler frequency shift value is a positive value, the processor adjusts the first value of the measured signal quality of the first network device by increasing the first value of the measured signal quality by an offset to obtain the adjusted first value.

7. The communications apparatus as claimed in claim 1, wherein when the first Doppler frequency shift value is a negative value, the processor adjusts the first value of the measured signal quality of the first network device by decreasing the first value of the measured signal quality by an offset to obtain the adjusted first value.

8. The communications apparatus as claimed in claim 1, wherein the processor further estimates a second Doppler frequency shift value corresponding to a second carrier frequency utilized for communicating with a second network device, and adjusts the second carrier frequency to an adjusted second carrier frequency according to the second Doppler frequency shift value and communicates with the second network device according to the adjusted second carrier frequency via the radio transceiver.

9. The communications apparatus as claimed in claim 1, wherein the processor further estimates a second Doppler frequency shift value corresponding to a second carrier frequency utilized for communicating with a second network device, and adjusts a second value of a measured signal quality of the second network device to an adjusted second value according to the second Doppler frequency shift value, wherein the processor further perform a cell selection procedure to select a suitable network device with better signal quality according to the adjusted first value and the adjusted second value, and performs a camp on procedure to camp on the suitable network device.

10. A method for enhancing performance of a communications apparatus suffering from Doppler effect, comprising:
estimating a Doppler frequency shift value corresponding to a carrier frequency utilized by the communications apparatus to communicate with a network device;
adjusting the carrier frequency to an adjusted carrier frequency according to the Doppler frequency shift value; and
using the adjusted carrier frequency to communicate with the network device.

11. The method as claimed in claim 10, wherein the carrier frequency is an uplink carrier frequency, and when the Doppler frequency shift value is a positive value, the step of adjusting the carrier frequency to an adjusted carrier frequency according to the Doppler frequency shift value comprises:
decreasing the carrier frequency by an offset to obtain the adjusted carrier frequency.

12. The method as claimed in claim 10, wherein the carrier frequency is an uplink carrier frequency, and when the Doppler frequency shift value is a negative value, the step of adjusting the carrier frequency to an adjusted carrier frequency according to the Doppler frequency shift value comprises:
increasing the carrier frequency by an offset to obtain the adjusted carrier frequency.

13. The method as claimed in claim 10, wherein the carrier frequency is an uplink carrier frequency, and the step of adjusting the carrier frequency to an adjusted carrier frequency according to the Doppler frequency shift value comprises:
subtracting the Doppler frequency shift value from the carrier frequency to obtain the adjusted carrier frequency.

14. A method for enhancing performance of a communications apparatus suffering from Doppler effect, comprising:
estimating a first Doppler frequency shift value corresponding to a first carrier frequency utilized by the communications apparatus to communicate with a first network device;
adjusting a first value of a measured signal quality of the first network device to an adjusted first value according to the first Doppler frequency shift value; and
performing a cell selection procedure or a measurement report procedure according to the adjusted first value.

15. The method as claimed in claim 14, further comprising:
transmitting a first measurement report with the adjusted first value to the first network device.

16. The method as claimed in claim 14, further comprising:
estimating a second Doppler frequency shift value corresponding to a second carrier frequency utilized by the communications apparatus to communicate with a second network device;
adjusting a second value of a measured signal quality of the second network device to an adjusted second value according to the second Doppler frequency shift value; and
transmitting a second measurement report with the adjusted second value to the first network device.

17. The method as claimed in claim 14, further comprising:
estimating a second Doppler frequency shift value corresponding to a second carrier frequency utilized by the communications apparatus to communicate with a second network device;
adjusting a second value of a measured signal quality of the second network device to an adjusted second value according to the second Doppler frequency shift value; and
selecting a suitable network device with better signal quality according to the adjusted first value and the adjusted second value, and performing a camp on procedure to camp on the suitable network device.

18. The method as claimed in claim 14, wherein when the first Doppler frequency shift value is a positive value, the step of adjusting a first value of a measured signal quality of the first network device to an adjusted first value according to the first Doppler frequency shift value comprises:
increasing the first value of the measured signal quality by an offset to obtain the adjusted first value.

19. The method as claimed in claim 14, wherein when the first Doppler frequency shift value is a negative value, the step of adjusting a first value of a measured signal quality of the first network device to an adjusted first value according to the first Doppler frequency shift value comprises:
decreasing the first value of the measured signal quality by an offset to obtain the adjusted first value.
